(19) United States
(12) Patent Application Publication
(10) Pub. No.: US 2024/0208669 A1
(43) Pub. Date: Jun. 27, 2024

(54) AUGMENTING PILOTED DISPLAY DATA WITH PROCESSED DATA

(71) Applicant: Lockheed Martin Corporation, Bethesda, MD (US)

(72) Inventors: Christopher A. Thornberg, Newtown, CT (US); Daniel M. Cooper, Seymour, CT (US); Stephen P. Lee, Shelton, CT (US); William C. Fell, Stuart, FL (US); Kenneth Burton Donovan, Apalachin, NY (US); Steven D. Marzella, Waterbury, CT (US); David L. Adams, Wallingford, CT (US)

(21) Appl. No.: 18/146,713

(22) Filed: Dec. 27, 2022

(51) Int. Cl. B64D 45/00; G06T 11/00

(52) U.S. Cl. CPC B64D 45/00; G06T 11/00

(57) ABSTRACT

Systems and methods for providing situational awareness to pilots of an aircraft. One example system includes an electronic processor configured to receive a raw sensor value for an operational characteristic of the aircraft and generate a processed sensor value based on the raw sensor value. The electronic processor is configured to provide the processed sensor value to a flight control system. The electronic processor is configured to generate a first digital gauge object that includes a graphical representation of the raw sensor value. The electronic processor is configured to generate a second digital gauge object that includes a graphical representation of the processed sensor value and a graphical representation indicating that the processed sensor value is being displayed. The electronic processor is configured to present the first digital gauge object on a first display of the aircraft and the second digital gauge object on a second display of the aircraft.

### FIELD

Embodiments described herein relate to pilot-configurable aircraft instrumentation.

### SUMMARY

Aircraft are equipped with sensors to measure operational characteristics including altitude and airspeed. Applicable civil regulations and military requirements mandate that certain types of aircraft sensor data must be presented on the flight displays of the aircraft for the pilots. In some cases, this sensor data must be from a single sensor source and must be presented in a raw format. As used herein, the terms “raw,” “raw data,” and “raw sensor data” refer to sensor data that is substantially unprocessed. However, many modern aircraft incorporate Fly-by-Wire (FBW) flight control systems. In such systems, it is common for the control algorithms that control the aircraft to utilize processed sensor data to improve redundancy, ride quality, and performance. As used herein, the terms “processed,” “processed data,” and “processed sensor data” include any combination of processing applied to the sensor data that noticeably alters the data statically and dynamically. Examples of such processing include filtering, inertial filtering, sensor fusion, and selection algorithms (also known as voting). Consequently, the processed parameters utilized by the flight control system may be dynamically and statically different than the unprocessed sensor data required to be displayed.

Because of these differences between unprocessed and processed values, it may appear to the pilots as if the flight control system is not performing as expected, particularly when asked to hold to a value (e.g., an altitude, a velocity, a heading, or an attitude). For example, a helicopter that performs naval operations typically has a radar altitude hold mode that is intended to keep the aircraft at a fixed height above the surface as measured by a radar altimeter sensor. However, an ocean surface dynamically varies due to waves, causing the raw sensor data from the radar altimeter to continually fluctuate. Direct use of this raw radar altimeter data is not desirable as it would continually raise and lower the helicopter height, referred to as “chasing waves.” Therefore, the radar altitude hold mode data would be processed, and potentially have the radar altimeter data inertially filtered, to improve ride quality by having the helicopter hold height above the water without actively chasing high waves. Traditionally, the pilot may see the unprocessed radar altimeter reading on the display dynamically changing as the waves pass underneath, while the radar altitude hold mode holds the aircraft much more steady inertially. This can give the impression that the flight controls are not accurately holding radar altitude because the pilot has no insight into either the actual radar altitude sensor solution within the flight control computer or the flight control performance.

Accordingly, examples described herein provide aircraft instrumentation that explicitly display the data being used to actively control the aircraft, while maintaining the ability for the crew to display independent raw sensor data within the cockpit. In this way, if a pilot sees any unexpectedly displayed differences between the held and requested sensor data, the pilot can select the voted and processed sensor data to confirm that the flight control system is performing as expected and that the dynamic and static differences observed using an independent unprocessed sensor data is to be expected. Some examples also provide for display of such information on each side of the cockpit and indications of when both sides are displaying the same source. Some examples also provide for cross cockpit comparison of displayed data to alert to crew that the displays are diverging beyond a threshold. Some examples also provide for the display to the pilot of voted data, to provide confidence to the pilot that the processed data represents the mutual agreement of multiple processors and sensors.

The examples and instances presented herein improve pilot situational awareness, instill confidence that the flight control system is operating as expected, and retain the ability for the crew to display independent unprocessed sensor data, keeping compliance with applicable regulations.

### BRIEF DESCRIPTION OF THE DRAWINGS

FIG. 1 schematically illustrates an aircraft instrumentation system, according to some examples.

FIG. 2 schematically illustrates an alternative aircraft instrumentation system, according to some examples.

FIG. 3 is a flowchart illustrating a method of depicting raw sensor data and processed sensor data, according to some examples.

FIG. 4 is an example user interface produced by the system of FIG. 1, according to some examples.

FIG. 5 is an example user interface produced by the system of FIG. 1, according to some examples.

FIG. 6 is an example user interface produced by the system of FIG. 1, according to some examples.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions. As used herein, the terms “graphical representation” and “display,” as they pertain to representing or displaying a value is not meant to limit the graphical form used to communicate the value. It could include, for example, numerical text, dials, bars, colors, and the like. It should also be understood that graphical representation or display of a value can communicate the value in absolute terms, such as a number corresponding to a first aircraft sensor value, or it may communicate the value in relative terms, such as the difference between the first aircraft sensor value and a second reference value.

Embodiments and examples described herein provide, among other things, aircraft instrumentation that explicitly display the voted and processed data being used to actively control the aircraft, while maintaining the ability for the crew to display independent “raw” sensor data on opposite sides of the cockpit.

In particular, one example describes a system for providing situational awareness to a pilot of an aircraft. The system includes an electronic processor. The electronic processor is configured to receive a raw sensor value for an operational characteristic of the aircraft. The electronic processor is configured to generate a processed sensor value based on the raw sensor value. The electronic processor is configured to provide the processed sensor value to a flight control system of the aircraft. The electronic processor is configured to generate a first digital gauge object based on the operational characteristic of the aircraft, wherein the first digital gauge object includes a graphical representation of the raw sensor value. The electronic processor is configured to generate a second digital gauge object based on the operational characteristic of the aircraft, wherein the second digital gauge object includes a graphical representation of the processed sensor value and a graphical representation indicating that the processed sensor value is being displayed. The electronic processor is configured to present, on a first display of the aircraft, the first digital gauge object. The electronic processor is configured to present, on a second display of the aircraft, the second digital gauge object.

Another example describes a method for providing situational awareness to a pilot of an aircraft. The method includes receiving a raw sensor value for an operational characteristic of the aircraft. The method includes generating a processed sensor value based on the raw sensor value. The method includes providing the processed sensor value to a flight control system of the aircraft. The method includes generating a first digital gauge object based on the operational characteristic of the aircraft, wherein the first digital gauge object includes a graphical representation of the raw sensor value. The method includes generating a second digital gauge object based on the operational characteristic of the aircraft, wherein the second digital gauge object includes a graphical representation of the processed sensor value and a graphical representation indicating that the processed sensor value is being displayed. The method includes presenting, on a first display of the aircraft, the first digital gauge object. The method includes presenting, on a second display of the aircraft, the second digital gauge object.

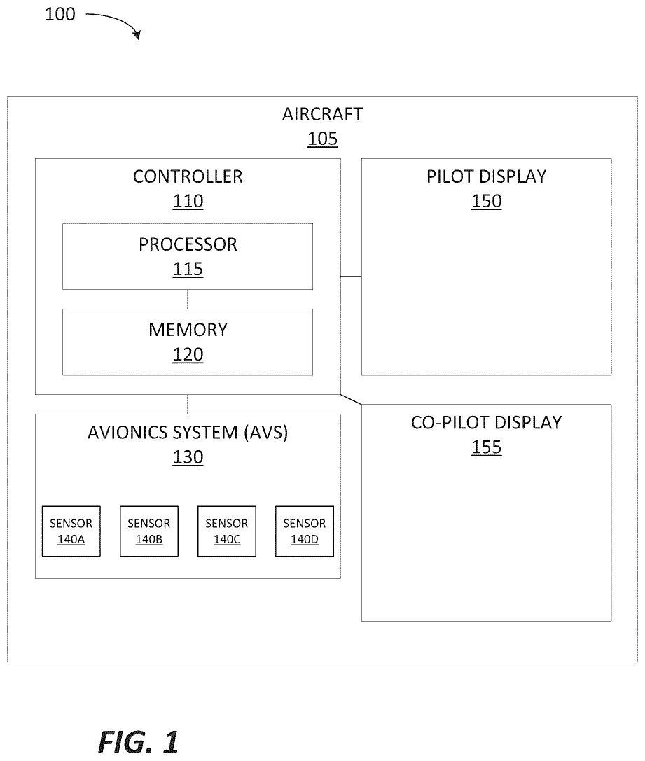

FIG. 1 illustrates an example system 100 for providing aircraft instrumentation and control. According to the example illustrated in FIG. 1, the system 100 is integrated into an aircraft 105. The aircraft 105 includes a controller 110, an avionics system (AVS) 130, a pilot display 150, and a co-pilot display 155. The components of the system 100 are communicatively coupled. The controller 110 is an electronic controller, which may include an electronic processor 115 and a memory 120. The memory 120 may be a non-transitory computer-readable memory. The memory 120 may include one or more types of memory storage, such as random-access memory (RAM), flash memory, solid-state memory, or hard-drive memory. In addition, or alternatively, the controller 110 may communicate with a cloud-based storage system. The controller 110 is typically implemented using well known redundancy mechanisms to guard against equipment failure within a single controller. Redundant controllers can employ a “voting” mechanism to determine the result to be used for further processing or display.

As illustrated, the AVS 130 may include a plurality of sensors (e.g., sensors 140A, 140B, 140C, 140D). Sensor types include Air Data system sensors (e.g., for sensing altitude and velocity), height above terrain sensors, and attitude/heading data. Each sensor generates a signal representing a measured operating characteristic of the aircraft 105 (e.g., altitude, velocity, position, attitude, heading, etc.) and transmits the signal to the controller 110 (directly or indirectly). The controller 110 receives and processes the signals. As described herein, the controller displays the measured characteristics received from the sensors on the pilot display 150, the co-pilot display 155, or both. For example, the controller may generate and display virtual gauges as part of a graphical user interface. In some instances, the raw sensor data is fed to the controller 110 and displayed in parallel, rather than the display data receiving raw sensor data from the controller 110. In such instances the pilot display 150 and the co-pilot display 155 are configured to display raw data, processed data, or both, regardless of the data path to the displays.

In some instances, the controller 110 is configured to operate the aircraft using fly-by-wire technology. In some instances (e.g., to improve redundancy, ride quality, and/or aircraft performance), the controller 110 is configured to utilize multiple sensors to sense a single operating characteristic of the aircraft 105. The controller 110 is configured process the data received from the sensors to determine an operating characteristic value that will be used by the fly-by-wire (FBW) flight control system during aircraft operation. For example, the controller 110 may implement a voting algorithm to select a sensor signal from among multiple received sensor signals. In another example, the controller 110 may process the sensor signals (individually or as a group) to normalize the data, to account for environmental or other factors, or to otherwise produce a more desirable sensor output. In some instances, a combination of approaches is used to generate the operating characteristic value used by the FBW flight control system. This value may vary from the raw sensor data received from each of the sensors. As described herein, the controller 110 is configured to display raw sensor data, processed sensor data (used by the FBW flight control system), or both.

It should be noted that, while voting and processing of sensor data is common in FBW controllers, it is also possible that traditional mechanical-based autopilot systems will significantly process the raw data and cause similar differences between the controlled sensor values and the raw sensor data. The systems and methods disclosed herein are also applicable to such mechanical flight control system autopilots, as well as to other technologies (e.g., fiber optics based fly-by-light systems).

In some embodiments, such as the embodiment illustrated in FIG. 1, the pilot display 150 and the co-pilot display 155 are integrated into the aircraft 105. For example, the pilot display 150 and the co-pilot display 155 may be electrically coupled to the controller 110, coupled to an instrument panel of the aircraft 105, or included in the AVS 130. In some instances, the pilot display 150, the co-pilot display 155, or both may provide a user interface for an electronic flight bag (EFB) application. In some instances, the displays include user input capabilities, such as a touch screen. In some instances, the displays may be or may include a heads up display (HUD). In some instances, the system 100 operates using, among other things, augmented reality technology, where live images are displayed or visible through the displays and augmented with text, graphics, or graphical user interface elements superimposed on or otherwise combined with the live images. In some embodiments, the system 100 operates using, among other things, virtual reality technology, where actual or simulated images are displayed (for example, on the displays) with text, graphics, or graphical user interface elements superimposed on or otherwise combined with the images.

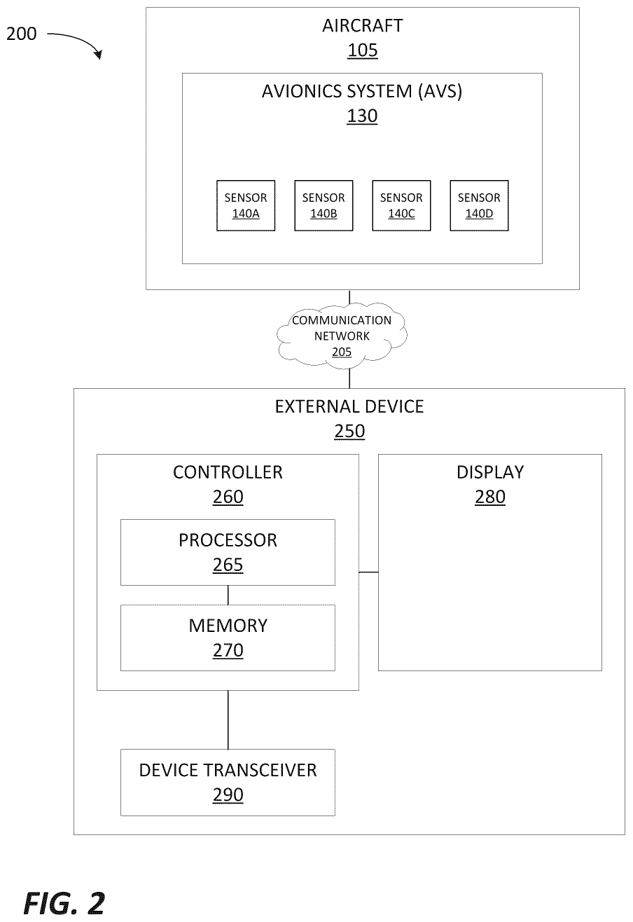

FIG. 2 illustrates an alternative system 200 for providing aircraft instrumentation and control. Unlike the system 100 illustrated in FIG. 1, the system 200 of FIG. 2 illustrates an alternative distributed configuration. The system 200 may include the aircraft 105, the AVS 130, and the sensors 140A-140D of the system 100 of FIG. 1. The system 200 further includes a communication network 205. The communication network 205 may be a Wi-Fi network, a cellular network, a Bluetooth network, a satellite network, or the like. The communication network 205 provides communicative coupling between the aircraft 105 and an external device 250. The external device 250 may be a mobile device, such as a smart phone, a tablet computer, a laptop computer, or the like. In some instances, the external device 250 is a device separate from the internal systems of the aircraft 105, but still physically located within the aircraft 105. For example, in these instances the external device 250 may be a tablet computer, a mobile phone, or the like. In other embodiments, the external device 250 is located external to the aircraft 105, for example in a control tower or in a ground control station, which may support remote operations.

The external device 250 includes a controller 260, a display 280, and a device transceiver 290. The device transceiver 290 and display 280 may be electrically, mechanically, and/or communicatively coupled to the controller 260. The controller 260 is an electronic controller, which may include a processor 265 and a memory 270. The memory 270 may be a non-transitory computer-readable memory. The memory 270 may include one or more types of memory storage, such as random-access memory (RAM), flash memory, solid-state memory, or hard-drive memory. In addition, or alternatively, the controller 260 may communicate with a cloud-based storage system. The device transceiver 290 is configured to send and receive signals to the aircraft 105 via the communication network 205.

In some instances, such as the example illustrated in FIG. 2, the display 280 is integrated into the external device 250, and not electrically or mechanically coupled to the aircraft 105. For example, the display 280 may be electrically and communicatively coupled to a mobile device, such as a smart phone or tablet computer. In some instances, the display 280 is configured to operate as a duplicate of either the pilot display 150 or the co-pilot display 155. In some instances, the display 280 operates as a replacement of either the pilot display 150 or the co-pilot display 155. In some instances, the display 280 operates as a supplement to the pilot display 150, the co-pilot display 155, or both. In some instances, the display 280 includes user input capabilities, such as a touch screen. In some instances, the display 280 may be a head-mounted display (HMD), an optical head-mounted display (OHMD), or the display of a pair of smart glasses. In some instances, the external device 250 operates using, among other things, augmented reality technology, where live images are displayed or visible through the display 280 and augmented with text, graphics, or graphical user interface elements superimposed on or otherwise combined with the live images. In some instances, the external device 250 operates using, among other things, virtual reality technology, where actual or simulated images are displayed (for example, on the display 280) with text, graphics, or graphical user interface elements superimposed on or otherwise combined with the images.

Furthermore, other variations than the system 100 shown in FIG. 1 and the system 200 shown in FIG. 2 are possible. For example, some instances may distribute the components of the system 100 or 200 across multiple devices.

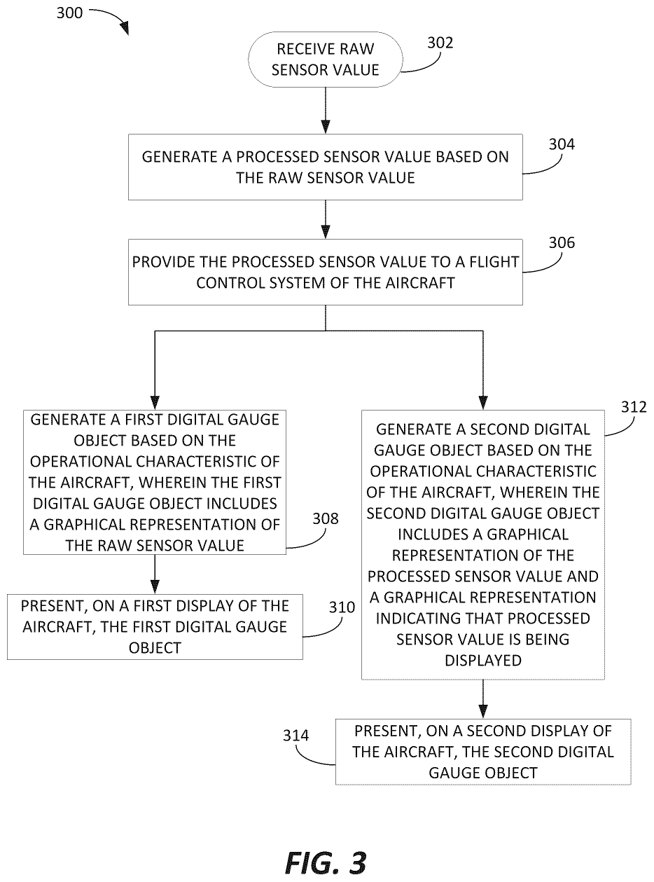

FIG. 3 is a flowchart illustrating a method 300 for providing situational awareness to a pilot of an aircraft by explicitly displaying voted and processed sensor data being used to actively control the aircraft. The method 300 may be implemented on the system 100 of FIG. 1, the system 200 of FIG. 2, and/or a different system. As an example, the method 300 is described as being performed by the electronic processor 115. However, the method 300 may be executed on one or more electronic processors according to examples described herein.

At block 302, the electronic processor 115 receives a raw sensor value for an operational characteristic of the aircraft. For example, the electronic processor may receive a raw sensor value from one or more of the sensors 140A-140D. In some aspects, one or more of the sensors 140A-140D provide a signal (e.g., a voltage) to the electronic processor, which converts the signal to a value for the operational characteristic (e.g., an altitude in feet). In some aspects, the electronic processor receives a value for the operational characteristic derived from the sensor signal by, for example, intervening circuitry. Examples of operational characteristics of the aircraft include an altitude of the aircraft, a velocity of the aircraft, an attitude of the aircraft, a position of the aircraft, and a heading of the aircraft.

At block 304, the electronic processor 115 generates a processed sensor value based on the raw sensor value in addition to other relevant information. For example, the electronic processor 115 may receive multiple raw sensor values and apply a selection algorithm to select one of the raw sensor values to use as the processed sensor value. In another example, the electronic processor 115 may receive multiple raw sensor values and apply a voting algorithm to arbitrate the results of multiple sensors such that the resulting value may be different than any single sensor value (e.g., average data). In another example, the electronic processor 115 may apply digital signal processing to the raw sensor value to produce the processed sensor value. In another example, electronic processor 115 may produce the processed sensor value using a rolling average or another suitable method to normalize the raw sensor data. In some aspects, the electronic processor 115 applies both a selection algorithm and processing to produce the processed sensor value. For example, the electronic processor 115 may select (using a selection algorithm) from one of multiple raw sensor values and apply processing to the selected raw sensor value to produce the processed sensor value. In another example, the electronic processor 115 may produce the processed sensor value by applying processing to several raw sensor values and then applying a voting or selection algorithm to select from among the several processed. In yet another example, the raw data may be significantly processed for display without being voted.

At block 306, the electronic processor 115 provides the processed sensor value to a flight control system of the aircraft. This sensor value is used by the FBW flight control system to operate the aircraft.

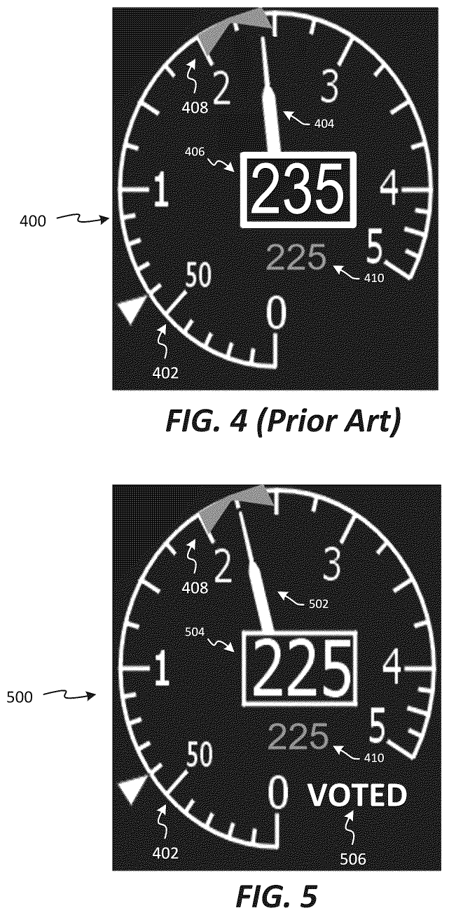

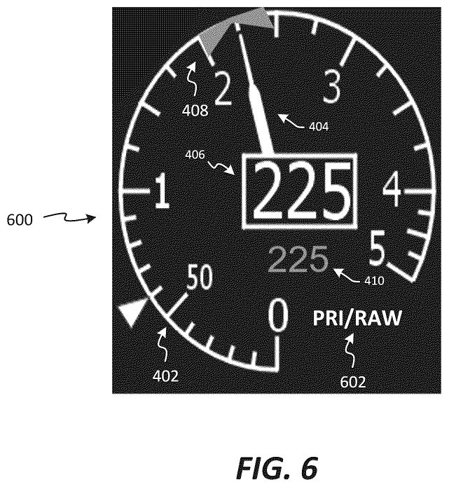

At block 308, the electronic processor 115 generates a first digital gauge object, based on the operational characteristic of the aircraft, that includes a graphical representation of the raw sensor value. A digital gauge object is a computer-generated dynamic image of an aircraft instrumentation gauge to be displayed to a pilot. FIG. 4 illustrates an example digital gauge object 400 representative of the prior art. The digital gauge object 400 is configured to display a radar altitude reading for the aircraft. The digital gauge object 400 includes a dial 402, which provides a numeric scale. In the illustrated example, the current value of the radar altitude is displayed using two different graphical representations. The first graphical representation is a needle 404, which is generated to overlay the dial at the point representing the current raw sensor value. The second graphical representation is a numeric indicator 406, which displays the current raw sensor value using, for example, Arabic numerals.

In some instances, the fly-by-wire system may be configured to hold the aircraft automatically, for example, at a particular reference value. In some aspects, the electronic processor 115 determines (e.g., by receiving an input from the flight control system) a reference value for the operational characteristic associated with the digital gauge and displays the reference value as well. In the illustrated example, the reference value is an altitude of 225 feet. In the illustrated example, the reference value is displayed using two different graphical representations. The first graphical representation is a notch 408, which is generated to overlay the dial at the point representing the current reference value. The second graphical representation is a numeric indicator 410, which displays the current reference value using, for example, Arabic numerals. In the prior art, minor variations to the raw sensor data, such as variations due to ocean waves, will cause continual variations in the display of the sensed value. Thus the needle 404 and indicator 406 may continually vary due to ocean wave height. For example, as illustrated in FIG. 4, the needle 404 and the numeric indicator 410 are displaying a current raw sensor data value of 235 feet (caused, for example, by a 10 foot wave under the aircraft while hovering above water), while the reference value is 225 feet. Such variations in the displayed sensed value may cause pilot confusion of whether the altitude sensors are working properly.

At block 310, the electronic processor 115 presents, on a first display of the aircraft (e.g., the pilot display 150), the first digital gauge object.

At block 312, the electronic processor 115 generates a second digital gauge object, based on the operational characteristic of the aircraft, that includes a graphical representation of the processed sensor value and a graphical representation indicating that the processed sensor value is being displayed. FIG. 5 illustrates an example second digital gauge object. The second digital gauge object is similar to the first, except that the second digital gauge object does not display the raw sensor value, but instead includes a graphical representation of the processed sensor value, which may be the needle 502, the numeric indicator 504, or both. The display of the processed sensor value effectively reduces the fluctuations of the raw sensor values. To improve pilot situational awareness, the second digital gauge object also includes a graphical representation indicating that the processed sensor value is being displayed. The second digital gauge object may also include a graphical representation indicating the confidence of the sensor value being displayed, to instill confidence in the pilot, the processed result may be indicated as “VOTED” to indicate it is agreed to by multiple redundant processors and sensors. In the illustrated example, the graphical representation is a textual indicator 506, which informs the pilot that the displayed sensor data is “VOTED.” In some examples, the graphical representation indicating that the processed sensor value is being displayed may be an icon, a shading of the gauge in a particular color, a change in color of one or more elements of the digital gauge object, a pulsating of the graphical representation of the processed sensor value, an alternate word (e.g., “PROCESSED”, “MISMATCH”), an outline, a glow, or another suitable means of highlighting to the pilot that processed sensor data is being displayed and if there is a potential sensor error.

At block 314, the electronic processor 115 presents, on a second display of the aircraft (e.g., the co-pilot display), the second digital gauge object.

In the example described above, a pilot may be provided a radar altimeter gauge displaying the raw sensor data, while a co-pilot is provided a radar altimeter gauge displaying the processed sensor data that is used by the flight control system. However, in some instances, a pilot or co-pilot may wish to select for themselves which data source to use. In some aspects, the avionics system 130 provides user inputs that allow pilots and/or co-pilots to select the data source to be displayed by a gauge. For example, the electronic processor 115 may generate a graphical user interface including touch-screen controls. In another example, existing physical controls (e.g., switches, buttons, knobs, and the like) may be configured such that their input reflects a pilot preference for a sensor data type.

In some instances, the electronic processor 115 may receive a user input indicative of either one of the first display or the second display, a sensor data type, and the operational characteristic of the aircraft. For example, a pilot may select a control presented on a graphical user interface, which indicates that they would like to see processed sensor data on their display. The electronic processor 115, in response to receiving this user input, will display the second digital gauge object on the pilot's display.

In some aspects, where multiple raw sensor values are available, the electronic processor 115 may be configured to produce alternate digital gauge objects to display the raw sensor values from different redundant sensors. For example, the electronic processor 115, where a second raw sensor value is available, may generate a third digital gauge object, based on the operational characteristic of the aircraft, which includes a graphical representation of the second raw sensor value. In some aspects, where multiple raw sensor values are available, the avionics system 130 provides user inputs that allow pilots and/or co-pilots to select the data source to be displayed by a gauge (e.g., a raw sensor value, a second raw sensor value, or a processed sensor value).

As noted, applicable regulations may require that at least one source of raw sensor data is presented to the pilots of an aircraft. Accordingly, in some aspects, the electronic processor 115 monitors the displays of the aircraft and the user inputs to determine whether at least one of the displays is displaying the raw sensor data (e.g., using the first or third digital gauge objects). In some aspects, the electronic processor 115 is configured to generate an alert (e.g., a visual alert, and audible alert, a haptic alert, and the like) when it determines that any of the first digital gauge object, the second digital gauge object, and the third digital gauge object is displayed on both of the co-pilot display and the pilot display. Such an alert ensures that both pilots are aware that they are viewing the same data source and may be used to enforce redundancy (e.g., by alerting the pilots that the crew is viewing the same source so they can take action if needed to view independent sensor data).

In some instances, the systems described herein may provide to a pilot or pilots awareness beyond observing the type of data displayed (e.g., voted, raw, processed, and the like). For example, in some instances the electronic processor 115 is configured to generate an alert indicate that there is a significant difference for that specific sensor type between what the pilot is viewing and one of the other sources of that data (e.g., other raw or processed data), for example, where the difference exceeds a threshold value (e.g., 5 knots for airspeed, 20 feet for altitude, and the like). For example, the electronic processor 115 may be configured to display a gauge or sensor label with an underline, a color change, in a special font, or in another way such as a dedicated indication (e.g., apart from the gauge or sensor label), an aural alert, a haptic alert, and the like. Such indications and alerts give the pilots awareness of the potential error, thereby reducing confusion were the system to react in an unexpected way (e.g., the pilot is viewing raw data, while an aircraft system is reacting to processed data). In this way, pilots need not manually compare the two values on different displays or toggle between settings. In some instances, the electronic processor 115 is configured to implement multiple options (e.g., providing two values and different displays, allowing pilots to toggle data sources, and presenting alerts where a significant difference is detected).

Therefore, embodiments described herein provide systems and methods for providing pilot situational awareness, which enhances safe operations of the aircraft. The examples presented herein allow each multifunction display of an aircraft to independently depict any selection of raw sensor data (from any available sensor) or a processed version of that sensor data. The examples presented herein do not in any way automatically restrict what data may be displayed at each station. However, in some instances, a system is configured to alert the crew of the aircraft when multiple stations are displaying the same source for situational awareness. In some instances, a system may be further configured to indicate when there is a significant difference between the presently displayed sensor data sources to help the crew isolate a potential sensor fault.

Various features and advantages of some embodiments are set forth in the following claims.

What is claimed is:

1. A system for providing situational awareness to a pilot of an aircraft, the system comprising:
one or more electronic processors configured to:
receive a raw sensor value for an operational characteristic of the aircraft;
generate a processed sensor value based on the raw sensor value;
provide the processed sensor value to a flight control system of the aircraft;
generate a first digital gauge object based on the operational characteristic of the aircraft, wherein the first digital gauge object includes a graphical representation of the raw sensor value;
generate a second digital gauge object based on the operational characteristic of the aircraft, wherein the second digital gauge object includes a graphical representation of the processed sensor value and a graphical representation indicating that the processed sensor value is being displayed;
present, on a first display of the aircraft, the first digital gauge object; and
present, on a second display of the aircraft, the second digital gauge object.

2. The system of claim 1, wherein the one or more electronic processors are further configured to:
receive a user input indicative of either one of the first display or the second display, a sensor data type, and the operational characteristic of the aircraft; and
present, on either one of the first display or the second display, either one of the first digital gauge object or the second digital gauge object, based on the sensor data type.

3. The system of claim 1, wherein the one or more electronic processors are further configured to:
receive a second raw sensor value for the operational characteristic of the aircraft; and
generate the processed sensor value based on the raw sensor value and the second raw sensor value.

4. The system of claim 3, wherein the one or more electronic processors are further configured to:
generate a third digital gauge object based on the operational characteristic of the aircraft, wherein the third digital gauge object includes a graphical representation of the second raw sensor value;
receive a user input indicative of either one of the first display or the second display, a sensor data type, and the operational characteristic of the aircraft; and
present, on either one of the first display or the second display, one selected from the group consisting of the first digital gauge object, the second digital gauge object, and the third digital gauge object, based on the sensor data type.

5. The system of claim 4, wherein the one or more electronic processors are further configured to:
responsive to determining that any of the first digital gauge object, the second digital gauge object, and the third digital gauge object is displayed on both of the first display and the second display, generate an alert.

6. The system of claim 1, wherein the one or more electronic processors are further configured to:
determine a reference value for the operational characteristic;
wherein the first digital gauge object includes a graphical representation of the reference value; and
wherein the second digital gauge object includes a second graphical representation of the reference value.

7. The system of claim 1, wherein the one or more electronic processors are further configured to:
determine a difference between the raw sensor value and the processed sensor value;
compare the difference to a threshold for the operational characteristic; and
when the difference exceeds the threshold, generate an alert indicating that there is a significant difference between what is displayed and one of the other sources of sensor data for the operational characteristic.

8. The system of claim 1, wherein the operational characteristic of the aircraft is one selected from the group consisting of an altitude of the aircraft, a velocity of the aircraft, an attitude of the aircraft, a position of the aircraft, and a heading of the aircraft.

9. The system of claim 1, wherein the first display and the second display are one selected from the group consisting of a display integrated into the aircraft, a display of a mobile device in communication with the aircraft, a heads up display, a head mounted display, a remote control display, and a remote monitoring display.

10. A method for providing situational awareness to a pilot of an aircraft, the method comprising:
receiving a raw sensor value for an operational characteristic of the aircraft;
generating a processed sensor value based on the raw sensor value;
providing the processed sensor value to a flight control system of the aircraft;
generating a first digital gauge object based on the operational characteristic of the aircraft, wherein the first digital gauge object includes a graphical representation of the raw sensor value;
generating a second digital gauge object based on the operational characteristic of the aircraft, wherein the second digital gauge object includes a graphical representation of the processed sensor value and a graphical representation indicating that the processed sensor value is being displayed;
presenting, on a first display of the aircraft, the first digital gauge object; and
presenting, on a second display of the aircraft, the second digital gauge object.

11. The method of claim 10, further comprising:
receiving a user input indicative of either one of the first display or the second display, a sensor data type, and the operational characteristic of the aircraft; and
presenting, on either one of the first display or the second display, either one of the first digital gauge object or the second digital gauge object, based on the sensor data type.

12. The method of claim 10, further comprising:
receiving a second raw sensor value for the operational characteristic of the aircraft; and
generating the processed sensor value based on the raw sensor value and the second raw sensor value.

13. The method of claim 12, further comprising:
generating a third digital gauge object based on the operational characteristic of the aircraft, wherein the third digital gauge object includes a graphical representation of the second raw sensor value;
receiving a user input indicative of either one of the first display or the second display, a sensor data type, and the operational characteristic of the aircraft; and
presenting, on either one of the first display or the second display, one selected from the group consisting of the first digital gauge object, the second digital gauge object, and the third digital gauge object, based on the sensor data type.

14. The method of claim 13, further comprising:
responsive to determining that any of the first digital gauge object, the second digital gauge object, and the third digital gauge object is displayed on both of the first display and the second display, generating an alert.

15. The method of claim 10, further comprising:
determining a reference value for the operational characteristic;
wherein the first digital gauge object includes a graphical representation of the reference value; and
wherein the second digital gauge object includes a second graphical representation of the reference value.

16. The method of claim 10, further comprising:
determining a difference between the raw sensor value and the processed sensor value;
comparing the difference to a threshold for the operational characteristic; and
when the difference exceeds the threshold, generating an alert indicating that there is a significant difference between what is displayed and one of the other sources of sensor data for the operational characteristic.

17. The method of claim 10, wherein the operational characteristic of the aircraft is one selected from the group consisting of an altitude of the aircraft, a velocity of the aircraft, an attitude of the aircraft, a position of the aircraft, and a heading of the aircraft.

18. The method of claim 10, wherein the first display and the second display are one selected from the group consisting of a display integrated into the aircraft, a display of a mobile device in communication with the aircraft, a heads up display, a head mounted display, a remote control display, and a remote monitoring display.

19. A system for providing situational awareness to a pilot of an aircraft, the system comprising:
one or more electronic processors configured to:
receive a raw sensor value for an operational characteristic of the aircraft;
generate a processed sensor value based on the raw sensor value;
provide the processed sensor value to a flight control system of the aircraft;
generate a first digital gauge object based on the operational characteristic of the aircraft, wherein the first digital gauge object includes a graphical representation of at least one of the raw sensor value and the processed sensor value;
generate a second digital gauge object based on the operational characteristic of the aircraft, wherein the second digital gauge object includes a graphical representation of at least one of the raw sensor value and the processed sensor value;
wherein, when the first digital gauge object includes the graphical representation of the processed sensor value, the first digital gauge object further includes a graphical representation indicating that the processed sensor value is being displayed;
wherein, when the second digital gauge object includes the graphical representation of the processed sensor value, the first digital gauge object further includes the graphical representation indicating that the processed sensor value is being displayed;
present, on either one of a first display of the aircraft or a second display of the aircraft, the first digital gauge object and the second digital gauge object.

20. The system of claim 19, wherein the one or more electronic processors are further configured to:
responsive to determining that the first digital gauge object and the second digital gauge object each include the graphical representation of the processed sensor value, generate a first alert; and
responsive to determining that the first digital gauge object and the second digital gauge object each include the graphical representation of the raw sensor value, generate a second alert.
